(19) United States
(12) Patent Application Publication
(10) Pub. No.: US 2020/0208606 A1
(43) Pub. Date: Jul. 2, 2020

(54) WIND POWER GENERATION DEVICE

(71) Applicant: Toshimitsu YAMAZAWA, Sapporo-shi, Hokkaido (JP)

(72) Inventor: Toshimitsu YAMAZAWA, Sapporo-shi, Hokkaido (JP)

(21) Appl. No.: 16/643,696

(22) PCT Filed: Sep. 4, 2018
(86) PCT No.: PCT/JP2018/032722

§ 371 Date: Mar. 2, 2020

(30) Foreign Application Priority Data
Sep. 4, 2017 (JP) 2017-169748

(51) Int. Cl. F03D 3/06; F03D 7/06

(52) U.S. Cl. CPC F03D 3/068; F03D 3/007; F03D 7/06

(57) ABSTRACT

To provide a wind power generation device in which wind received at the convex-side surface of concave panel parts is guided into a front edge airflow reservoir, thereby making it possible to improve the reliability of starting at startup and to increase the amount of power generated.

Wind-receiving paddles 5 have: concave panel parts 51, which have a vertically elongated shape and which curve or bend in a concave shape on an inner-side surface 516 or an outer-side surface 515 in plan view; and front edge airflow reservoirs 52 formed in a projecting manner on a concave-side-surface 511 side along the longitudinal direction of front edge parts 513 of the concave panel parts 51 with respect to the direction of rotation, the tip section of the front edge airflow reservoirs 52 curving or bending towards the rear-edge side. Airflow guide paths 53 for guiding an airflow that strikes a convex-side surface 512 from the rear-edge side toward the concave-side-surface 511 side and to the front edge airflow reservoirs 52 are formed, on the concave panel parts 51, along the longitudinal direction of the wind-receiving paddles 5.

### TECHNICAL FIELD

The present invention relates to a paddle-type wind power generation device.

### BACKGROUND ART

In the world, there are a lot of people who cannot enjoy the benefits of electricity, for example, people living in areas devoid of power generation equipment or power lines, and people without fixed residences such as nomads. In view of this, power has been conventionally obtained by a generator which can be easily installed, such as a small photovoltaic power generation panel. However, the photovoltaic power generation panel can only perform power generation during the daytime when sunlight is available, and cannot provide electric power at night when electric power is most needed for illumination, etc.

In contrast, wind is generated day and night. Thus, a wind power generation device, which generates power by wind power, is one of the optimum devices for obtaining electric power at night. However, the wind power generation device, which is rotated by lift generated in a propeller, does not start unless it receives a wind of a predetermined wind velocity or more. There has been developed a generator that can be started at a low wind velocity range of 3 m/s or less. To start the generator, however, the wind must blow from a direction substantially perpendicular to the propeller, and it is actually difficult to start the generator at a wind velocity of 3 m/s or less.

In view of the abovementioned problem, there has been proposed an invention relating to a paddle type wind power generation device which can be started even by a low-velocity wind from any direction.

For example, in Japanese Patent No. 5972478, there is disclosed by the present inventor a wind power generation device including: a perpendicular rotation shaft transmitting a rotational force to a wind power generation motor; a plurality of support arms provided at equal intervals radially from the perpendicular rotation shaft; and a wind receiving paddle connected to the distal end of each support arm, wherein the wind receiving paddle is equipped with: a concave panel part formed by curving or bending an outer surface side thereof in plan view into a concave shape; and a front edge airflow reservoir portion which protrudes on the outer surface side along the front edge part in the rotational direction of the concave panel part and the distal end portion of which is curved or bent to a rear edge part side, with the length from the connection portion with the support arm of the wind receiving panel to the rear edge part being formed to be longer than the support arm (Patent Literature 1). According to the invention of Patent Literature 1, the wind is concentrated at the front edge airflow reservoir portion to obtain a force in the rotational direction, and when the wind is received by the front edge side, the projection area thereof is diminished to thereby facilitate the rotation, making it possible to achieve an improvement in terms of power generation efficiency.

### CITATION LIST

### Patent Literature

Patent Literature 1: Japanese Patent No. 5972478

### SUMMARY OF INVENTION

### Technical Problem

In the invention disclosed in Patent Literature 1, the wind received by the convex side surface of the concave panel part is turned into a force to press the wind receiving paddle and contributes to the rotation of the perpendicular rotation shaft. However, the convex side surface is curved or bent, so that depending on the direction in which the wind is received, the wind is likely to flow away along the convex side surface, and, in some cases, cannot be sufficiently utilized as the force for rotating the paddle. Thus, there is room left for improvement in terms of effect through conversion of the wind force received by the convex side surface to the rotational force of the perpendicular rotation shaft.

The present invention has been made with a view toward solving the abovementioned problem. It is an object of the present invention to provide a wind power generation device in which the wind received by the convex side surface of the concave panel part is guided to the front edge airflow reservoir portion, thereby enhancing the reliability in startup at the time of starting-up and making it possible to increase the amount of power generated.

### Solution to Problem

In order to effectively utilize the wind received by the convex side surface of the concave panel part as the rotational force of the wind receiving paddle, there is provided, in accordance with the present invention, a wind power generation device including: a perpendicular rotation shaft transmitting a rotational force to a wind power generation motor; a plurality of support arms arranged at equal intervals with respect to a circumferential direction and radially from the perpendicular rotation shaft; and a wind receiving paddle connected to a distal end of each support arm, wherein the wind receiving paddle has: a concave panel part vertically elongated and formed by curving or bending an inner side surface or an outer side surface into a concave shape in plan view; and a front edge airflow reservoir portion which is formed to protrude to a concave side surface side along a longitudinal direction of a front edge part in a rotational direction of the concave panel part and a distal end portion of which is formed by being curved or bent to a rear edge side, and the concave panel part has an airflow guide path which is formed along the longitudinal direction of the wind receiving paddle and which serves to introduce an airflow striking the convex side surface from the rear edge side to the concave side surface side to guide the airflow to the front edge airflow reservoir portion.

In a mode of the present invention, in order to make it easy to guide the wind received by the convex side surface of the concave panel part directly to the front edge airflow reservoir portion, the airflow guide path may have a front edge side airflow guide path which is on the convex side surface side of the front edge part of the concave panel part and which is formed along the longitudinal direction thereof.

Further, in a mode of the present invention, in order to guide the wind received by the convex side surface of the concave panel part and the rear edge side thereof into the front edge airflow reservoir portion, the airflow guide path may have, along with the front edge side airflow guide path, a rear edge side airflow guide path which is on the rear edge side of the front edge side airflow guide path and which serves to guide the airflow striking the convex side surface on the rear edge side of the formation position thereof to the concave surface side.

In a mode of the present invention, in order to accelerate the velocity of the airflow discharged from the airflow guide path, the airflow guide path may be formed so as to be gradually narrowed from the rear edge side toward the front edge side.

Further, in a mode of the present invention, in order to reduce the frictional resistance between the perpendicular rotation shaft and a shaft support stand supporting it, the perpendicular rotation shaft may be rotatably supported by the shaft support stand in a floating state by a repulsive force of pairs of upper and lower magnets provided at a plurality of positions along the axial direction.

### Advantageous Effects of Invention

According to the present invention, the wind received by the convex side surface of the concave panel part is guided into the front edge airflow reservoir portion, whereby it is possible to enhance the reliability in startup at the time of starting-up and to increase the amount of power generated.

### BRIEF DESCRIPTION OF DRAWINGS

FIG. 1 is a perspective view of a wind power generation device according to a first embodiment of the present invention.

FIG. 2 is a longitudinal sectional view of the interior of a shaft support stand of the first embodiment.

FIG. 3 is a plan view, partially in cross-section, of the wind power generation device of the first embodiment, illustrating a wind receiving paddle thereof.

FIG. 4 is a cross-sectional view of the wind receiving paddle viewed in plan view of the first embodiment.

FIG. 5 is a plan view of the first embodiment, illustrating the flow of air with respect to the wind power generation device in the case where the wind is received from the wind receiving paddle 5A side.

FIG. 6 is a plan view of the first embodiment, illustrating the flow of air with respect to the wind power generation device in the case where the wind is received from between a wind receiving paddle 5A and a wind receiving paddle 5B.

FIG. 7 is a cross-sectional view of a wind receiving paddle of a wind power generation device viewed in plan view according to a second embodiment of the present invention.

FIG. 8 is a plan view of the second embodiment, illustrating the flow of air with respect to the wind power generation device in the case where the wind is received from the wind receiving paddle 5A side.

FIG. 9 is a plan view of the second embodiment, illustrating the flow of air with respect to the wind power generation device in the case where the wind is received from between the wind receiving paddle 5A and the wind receiving paddle 5B.

FIG. 10 is a plan view, partially in cross-section, of a wind receiving paddle of a wind power generation device according to another embodiment of the present invention.

FIG. 11 is a plan view, partially in cross-section, of a wind receiving paddle of a wind power generation device according to another embodiment of the present invention.

FIG. 12 is a plan view, partially in cross-section, of a wind receiving paddle of a wind power generation device according to another embodiment of the present invention.

### DESCRIPTION OF EMBODIMENTS

In the following, a wind power generation device according to the first embodiment of the present invention will be described with reference to the drawings.

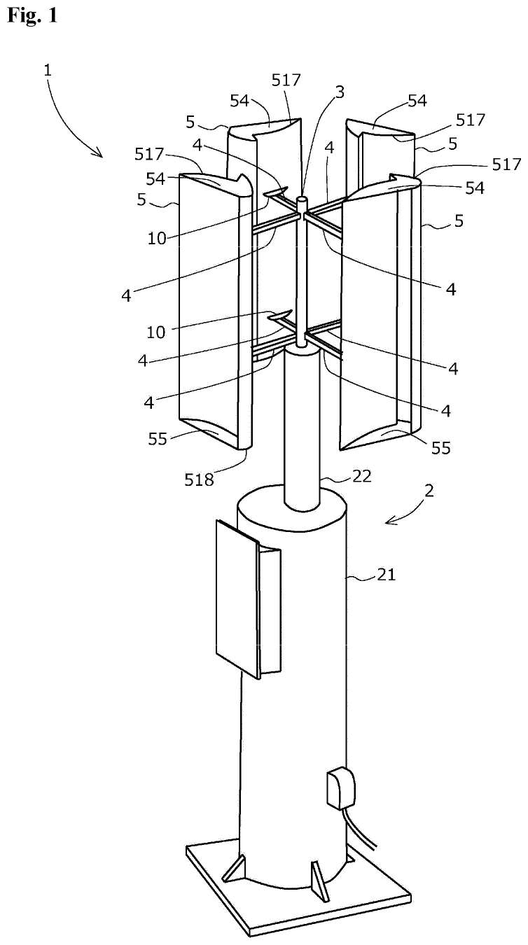

As shown in FIG. 1, the wind power generation device 1 of the first embodiment has a shaft support stand 2 fixed in position at the place installation, a perpendicular rotation shaft 3 rotatably supported by the shaft support stand 2, a plurality of support arms 4 provided so as to radially extend from the perpendicular rotation shaft 3, and a wind receiving paddle 5 supported at the distal end of each support arm 4. In the following, the structure of each component will be described in detail.

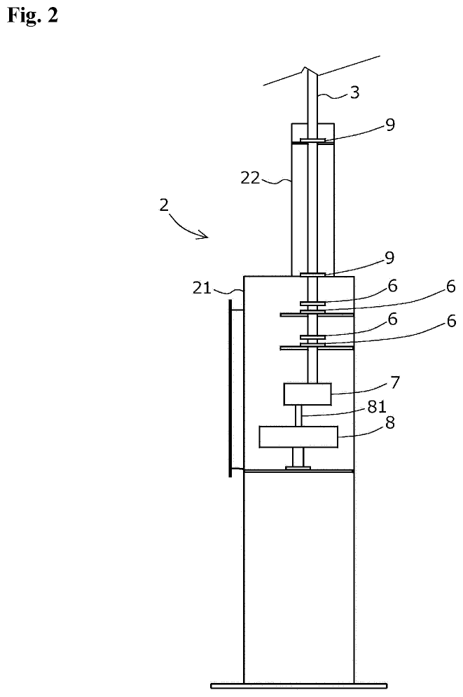

The shaft support stand 2 is a stand rotatably supporting the perpendicular rotation shaft 3. As shown in FIG. 2, the shaft support stand 2 of the present embodiment mainly has a substantially cylindrical main body portion 21 equipped with a power generation mechanism, and a substantially cylindrical upper portion support portion 22 formed on the upper surface of the main body portion 21 and supporting the perpendicular rotation shaft 3.

The main body portion 21 is hollow, and contains magnets 6 placing the perpendicular rotation shaft 3 in a floating state, a rotation transmission mechanism 7 transmitting the rotational force of the perpendicular rotation shaft 3 to the wind power generation motor 8, and the wind power generation motor 8 performing power generation by the rotational force of the perpendicular rotation shaft 3.

There are provided pairs of upper and lower magnets 6. The same poles (positive poles, or negative poles) are arranged opposite each other, and their repulsive force places the perpendicular rotation shaft 3 in a floating state, whereby the frictional resistance between the perpendicular rotation shaft and the shaft support stand 2 is reduced. In the first embodiment, the magnets 6 consist of donut-shaped neodymium magnets, one of which is fixed to the main body portion 21 side, and the other of which is fixed to the perpendicular rotation shaft 3 side. The pairs of upper and lower magnets 6, 6 are provided at a plurality of positions (two upper and lower positions in the present embodiment) along the axial direction, making it possible to maintain the floating state of the perpendicular rotation shaft 3 by a stronger magnetic force. The magnets 6 are not restricted to neodymium magnets but may be selected as appropriate from permanent magnets, electromagnets, etc.

The rotation transmission mechanism 7 serves to transmit the rotational force of the perpendicular rotation shaft 3 to the wind power generation motor 8. In the first embodiment, it consists of a plurality of gears, and is endowed with a velocity increasing function by which it increases the rotation speed of the wind power generation motor 8. That is, through an appropriate combination of the plurality of gears, the rotation transmission mechanism 7 of the first embodiment can rotate the wind power generation motor 8 at a rotation speed higher than that of the perpendicular rotation shaft 3, whereby it is possible to provide a large amount of power as compared with the case where the perpendicular rotation shaft 3 and the wind power generation motor 8 are directly connected to each other.

The wind power generation motor 8 serves to convert the rotational force of the perpendicular rotation shaft 3 transmitted by the rotation transmission mechanism 7 to electric power. The wind power generation motor 8 according to the first embodiment is a general power generation motor, and, although not shown in detail, has a rotation shaft 81 rotatably supported, a permanent magnet with which the rotation shaft 81 is equipped, and an electric coil arranged in the periphery of the rotating permanent magnet. The rotation shaft 81 is connected to the rotation transmission mechanism 7, and the permanent magnet is rotated by the rotational force of the perpendicular rotation shaft 3 transmitted by the rotation transmission mechanism 7, generating an electric current in the electric coil arranged in the periphery thereof. Further, although not shown, the wind power generation motor 8 is connected to a power line, a storage battery, an electronic apparatus, etc., and the electric power generated is supplied to the power line, the storage battery, the electronic apparatus, etc.

The upper portion support portion 22 is formed as a longitudinally elongated hollow cylinder. Inside the upper portion support portion 22, there are provided, at two positions: the upper portion thereof and the lower portion thereof or the upper portion of the main body portion 21, bearings 9, 9 mitigating the energy loss due to the friction during the rotation of the perpendicular rotation shaft 3. In this way, the upper portion support portion 22 supports the perpendicular rotation shaft 3 at two upper and lower positions: the upper position thereof in the vicinity of the support arms and the lower position lower than them, whereby deflection of the perpendicular rotation shaft 3 due to the wind force received by the wind receiving paddles 5, etc. is suppressed.

The perpendicular rotation shaft 3 is rotated by the wind force received by the wind receiving paddles 5. The perpendicular rotation shaft 3 of the first embodiment is formed of a steel pipe, aluminum pipe or the like, which is lightweight and of high strength, and, as shown in FIG. 2, is rotatably supported by the shaft support stand 2 with the rotation axis direction thereof being substantially vertical. The lower end portion of the perpendicular rotation shaft 3 is fixed to the rotation transmission mechanism 7. The perpendicular rotation shaft 3 extends upwards beyond the upper portion support portion 22, and allows fixation of a support arm 4 described below.

The support arm 4 transmits the wind force obtained by the wind receiving paddle 5 to the perpendicular rotation shaft 3 as the rotational force, and a plurality of support arms are arranged radially from the perpendicular rotation shaft 3 and at equal intervals with respect to a circumferential direction. As shown in FIG. 1, in the first embodiment, at the upper end of the perpendicular rotation shaft 3 and in the vicinity of the upper portion support portion 22, there are respectively provided four support arms 4 at a circumferential interval of 90 degrees. As a result, the support arms 4 support four wind receiving paddles 5 in total, and can rotate the perpendicular rotation shaft 3 by receiving the wind from any of the four directions by the wind receiving paddles 5, as described below. There are no particular restrictions regarding the number of support arms 4, the circumferential interval thereof, etc., which may be selected as appropriate taking the number of wind receiving paddles 5 supporting, the configuration, weight thereof, etc. into consideration.

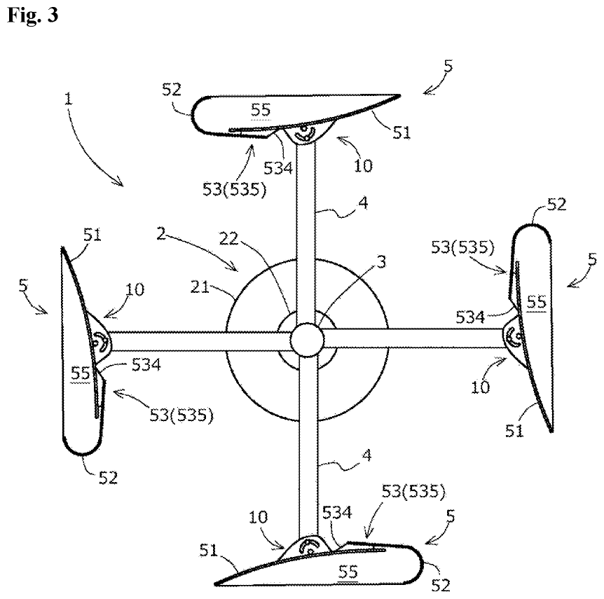

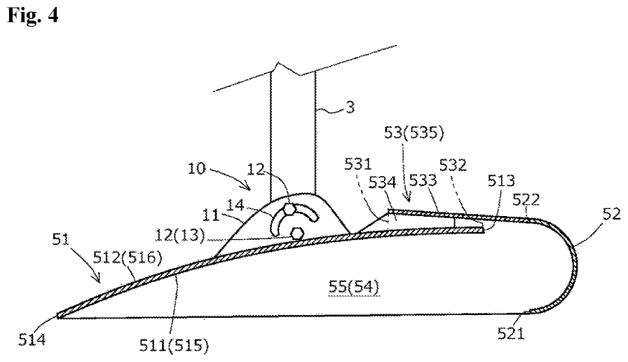

Next, the wind receiving paddle 5 of the first embodiment will be described. The wind receiving paddle 5 receives the wind and, due to the force thereof, generates a rotational force with respect to the perpendicular rotation shaft 3. As shown in FIGS. 3 and 4, the wind receiving paddle 5 of the first embodiment has a concave panel part 51 guiding the wind received by the concave side surface 511 to the front edge part 513 side, a front edge airflow reservoir portion 52 receiving the wind guided by the concave panel part 51 and converting the wind force to a rotational force, and an airflow guide path 53 guiding the airflow striking the convex side surface 512 of the concave panel part 51 to the concave side surface 511 side and guiding it to the front edge airflow reservoir portion 52. As shown in FIG. 1, the wind receiving paddle 5 of the first embodiment has an upper edge airflow stop portion 54 and a lower edge airflow stop portion 55 for preventing the air received by the concave panel part 51 from escaping from the vertical direction.

As shown in FIGS. 1, 3, and 4, the concave panel part 51 is formed by curving or bending the inner side surface 516 or the outer side surface 515 into a concave shape in plan view in the state in which the vertically elongated substantially rectangular panel is fixed to the support arm 4. As shown in FIGS. 3 and 4, the concave panel part 51 is formed such that the outer side surface 515 is curved into a concave shape in plan view. As a result, the wind heading for the perpendicular rotation shaft 3 from the outer side and the wind blowing from the rear edge side toward the front edge side (from the rear edge part 514 side to the front edge part 513 side) can be easily guided in the direction of the front edge. Further, the wind receiving paddle 5 is formed in a substantially wing-like configuration, whereby in the case where the wind receiving paddle 5 receives an airflow from the front edge side, the wind velocity at the convex side surface 512 is higher than that at the concave side surface 511 to place the convex side surface 512 side in more negative pressure than at the concave side surface 511, thereby spouting air from an airflow guide path 53 described below to obtain a thrust force (rotational force).

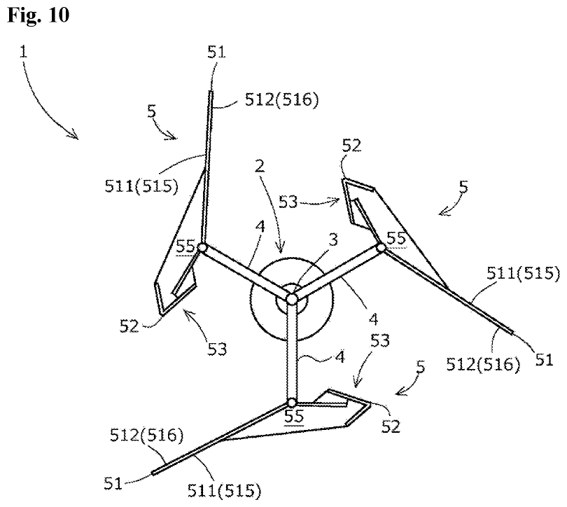

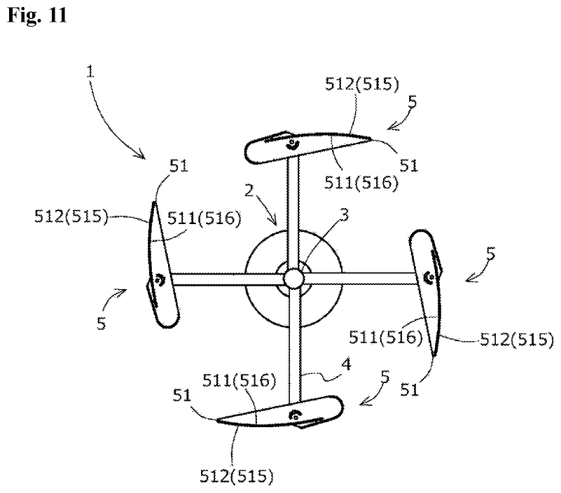

The concave panel part 51 is not restricted to the configuration curved in plan view. As shown in FIG. 10, it may be formed by bending a linear panel in plan view or connecting and bending a plurality of panels. While the concave panel part 51 of the first embodiment is formed such that the outer side surface 515 is concave in plan view, it may also be formed, as shown in FIG. 11, such that the inner side surface 516 is concave in plan view. The effect of the concave panel part 51 formed so as to be concave at the inner side surface 516 in plan view will be described below with regard to the second embodiment.

The front edge airflow reservoir portion 52 is a portion receiving the wind received by the concave panel part 51 at the front edge part 513 to convert it to a rotational force, and is formed so as to protrude to the concave side surface 511 side along the longitudinal direction of the front edge part 513 in the rotational direction of the concave panel part 51, with the distal end portion 521 thereof being curved or bent toward the rear edge side. The front edge airflow reservoir portion 52 of the first embodiment consists of what is obtained through longitudinal halving of an aluminum pipe for a reduction in weight, and is formed in a substantially semicircular configuration in plan view. As shown in FIGS. 3 and 4, in the front edge airflow reservoir portion 52, the rear end portion 522 on the concave panel part 51 side is arranged on the inner side of the convex side surface 512 of the concave panel part 51 so that it may constitute the airflow discharge port 532 of the airflow guide path 53 along with the concave panel part 51. That is, a gap is formed between the rear end portion 522 of the front edge airflow reservoir portion 52 and the front edge part 513 of the concave panel part 51, whereby it is possible to guide the airflow striking the convex side surface 512 from the rear edge side of the concave panel part 51 to the concave side surface 511 side. As shown in FIGS. 1, 3, and 4, the front edge airflow reservoir portion 52 is connected to the concave panel part 51 via the upper edge airflow stop portion 54, the lower edge airflow stop portion 55, and a partition 534 of the airflow guide path 53 described below. The front edge airflow reservoir portion 52 is not restricted to the one formed by a pipe but may be selected as appropriate from among what are obtained through bending, connection, etc. of a longitudinally elongated substantially rectangular panel member such that its distal end portion 521 is directed to the rear edge side as shown in FIG. 10.

The airflow guide path 53 serves to guide the airflow striking the convex side surface 512 of the concave panel part 51 from the rear edge side to the concave side surface 511 side thereof and to guide it to the front edge airflow reservoir portion 52, and is formed in the concave panel part 51. As shown in FIGS. 3 and 4, the airflow guide path 53 has an airflow introduction port 531 introducing the airflow striking the convex side surface 512 from the rear edge side on the convex side surface 512 side, and an airflow discharge port 532 discharging the airflow introduced from the airflow introduction port 531 toward the front edge airflow reservoir portion 52 on the front edge side. (The dashed line shown in FIG. 4 is an imaginary line given for the sake or convenience to indicate the airflow introduction port 531 and the airflow discharge port 532, and does not indicate a contour line or the like). The airflow guide path 53 of the first embodiment is formed by the convex side surface 512 of the concave panel part 51, an airflow guide plate 533 arranged side by side with the convex side surface 512, and a plurality of partitions 534 dividing a gap formed between the convex side surface 512 and the airflow guide plate 533 at predetermined longitudinal intervals. Although the division in the longitudinal division by the partitions 534 is not shown, there is no particular restriction regarding the divisional number, and it is selected as appropriate.

The airflow guide plate 533 of the first embodiment consists of a longitudinally elongated substantially rectangular panel member, and, as shown in FIGS. 3 and 4, extends from the rear end portion 522 of the front edge airflow reservoir portion 52 toward the rear edge side. That is, the airflow guide path 53 of the first embodiment is on the convex side surface 512 side of the front edge part 513 of the concave panel part 51, and is formed along the longitudinal direction thereof, and is formed as the front edge side airflow guide path 535.

The partitions 534 connect the airflow guide plate 533, the front edge airflow reservoir portion 52, and the concave panel part 51, and generate disturbance in the airflow by slashing the airflow striking the convex side surface 512 from the rear edge side, thereby making it easy for the airflow to be introduced into the airflow guide path 53. As shown in FIGS. 3 and 4, the partitions 534 are formed in a substantially trapezoidal configuration in plan view, and extend to the rear edge side beyond the airflow introduction port 531 so that they can easily slash the airflow on the upstream side of the airflow introduction port 531.

The partition 534 is formed such that on the front edge side, the height of the trapezoidal configuration (the distance between the convex side surface 512 and the airflow guide plate 533) is smaller (shorter) than on the rear edge side. Thus, the airflow guide path 53 of the first embodiment is formed so as to be gradually narrowed from the rear edge side toward the front edge side. The airflow guide path 53 is narrowed to accelerate the airflow introduced from the airflow introduction port 531 to discharge it from the airflow discharge port 532, thereby enhancing the force with which the front edge airflow reservoir portion 52 is thrust in the rotational direction by the wind force guided to the front edge airflow reservoir portion 52.

An upper edge airflow stop portion 54 serves to receive the airflow received by the concave panel part 51 so that it may not escape from the upper edge thereof. As shown in FIG. 1, the upper edge airflow stop portion 54 of the first embodiment is provided on the concave side surface 511 side of the concave panel part 51 so as to cover an upper edge portion 517 of the portions from the concave panel part 51 to the front edge airflow reservoir portion 52.

Like the upper edge airflow stop portion 54, a lower edge airflow stop portion 55 serves to receive the airflow received by the concave panel part 51 so that it may not escape from the lower edge thereof. As shown in FIG. 1, the lower edge airflow stop portion 55 of the first embodiment is provided on the concave side surface 511 side of the concave panel part 51 so as to cover a lower edge portion 518 of the portions from the concave panel part 51 to the front edge airflow reservoir portion 52.

The wind receiving paddle 5 constructed as described above is supported by each support arm 4 with its front edge side directed in the rotational direction. At the connection portion between each support arm 4 and the wind receiving paddle 5, there is provided an angle adjustment mechanism 10, making it possible to properly adjust the angle of the wind receiving paddle 5 with respect to the rotational direction in plan view. As shown in FIGS. 3 and 4, the angle adjustment mechanism 10 of the first embodiment has a support plate 11 fixed to the convex side surface 512 of the concave panel part 51, and two support bolts 12, 12 fixing the support plate 11 to the support arm 4. Formed in the support plate 11 are a bolt hole 13 into which one support bolt 12 is inserted, and an arcuate elongated hole 14 which is formed along the arc around the bolt hole 13 and into which the other support bolt 12 is inserted. That is, by inserting one support bolt 12 into the bolt hole 13 and fixing it to the support arm 4, the angle adjustment mechanism 10 rotatably supports the wind receiving paddle 5, and, at the same time, is fixed to the support arm 4 after inserting the other support bolt 12 into the elongated hole 14 and adjusting the angle of the wind receiving paddle 5 as appropriate.

Next, the operation of each structure of the wind power generation device 1 of the first embodiment will be described.

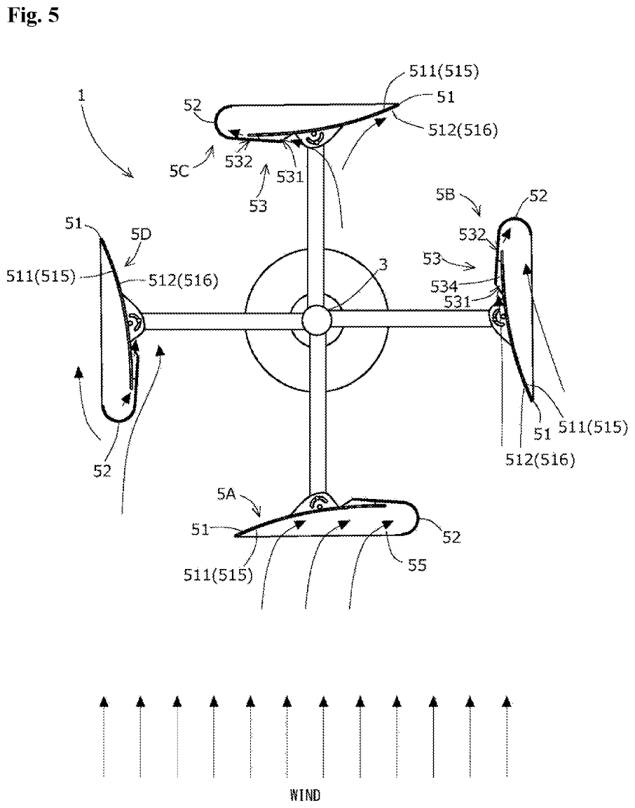

To be described will be the case where as shown in FIG. 5, in the wind power generation device 1 of the first embodiment, there is received the wind blowing from the direction of one wind receiving paddle 5A toward the opposite wind receiving paddle 5C with respect to the perpendicular rotation shaft 3 (the wind blowing upwards from below in FIG. 5).

In this case, in the wind receiving paddle 5A situated most windward, mainly the concave side surface 511 of the concave panel part 51 receives the wind. The concave side surface 511 is curved and inclined toward the front edge side, the concave panel part 51 guides the received wind from the rear edge side to the front edge side along the curved surface thereof (the concave side surface 511).

The front edge airflow reservoir portion 52 receives the wind guided from the rear edge side to the front edge side by the concave panel part 51, and converts the wind force to a force toward the front edge. At this time, the upper edge airflow stop portion 54 and the lower edge airflow stop portion 55 provided at the upper edge portion 517 and the lower edge portion 518 of the concave panel part 51 prevent the air from escaping in the vertical direction. Thus, the major portion of the wind received by the concave side surface 511 of the concave panel part 51 is guided to the front edge airflow reservoir portion 52 to become a thrust force in the front edge direction.

Next, to be described will be the effect of the wind received by the wind receiving paddle 5B arranged at an interval of 90 degrees in the rotational direction with respect to the wind receiving paddle 5A (the wind receiving paddle 5B arranged on the right side in FIG. 5). With respect to the wind receiving paddle 5B, the wind blows from the rear edge side toward the front edge side. Thus, the airflow flowing on the concave side surface 511 of the concave panel part 51 is guided to the front edge airflow reservoir portion 52 along the concave panel part 51, or directly flows into the front edge airflow reservoir portion 52 to become a thrust force toward the front edge.

On the other hand, the airflow striking the convex side surface 512 of the concave panel part 51 flows along the convex side surface 512. At this time, the partitions 534 extending to the upstream side of the airflow introduction port 531 of the airflow guide path 53 impart disturbance to the airflow. As a result, it becomes easy for the airflow to flow into the airflow guide path 53 from the airflow introduction port 531. Then, the airflow flows into the airflow guide path 53 from the airflow introduction port 531.

In the airflow guide path 53, the sectional area thereof is gradually diminished from the airflow introduction port 531 toward the airflow discharge port, so that the airflow flowing in is accelerated in accordance with the sectional area. Then, the accelerated airflow is discharged from the airflow discharge port 532, and is guided to the front edge airflow reservoir portion 52. The airflow guided to the concave side surface 511 side from the convex side surface 512 by the airflow guide path 53 is turned into a force thrusting the front edge airflow reservoir portion 52 in the direction of the front edge by an accelerated strong force. Thus, in the wind receiving paddle 5 of the first embodiment, it is possible to utilize the airflow striking the convex side surface 512 from the rear edge side, which has not been conventionally much used as the thrust force toward the front edge, since it flows away along the convex side surface 512.

Next, to be described will be the wind receiving paddle 5C arranged at an interval of 90 degrees in the rotational direction with respect to the wind receiving paddle 5B (the wind receiving paddle 5C arranged on the most leeward side in FIG. 5). In the wind receiving paddle 5C, the wind is received by the convex side surface 512. At this time, the airflow in contact with the convex side surface 512 flows along the convex side surface 512. And a portion of the airflow flows into the airflow guide path 53. Since the airflow discharge port 532 is open toward the front edge airflow reservoir portion 52 side, the air flowing into the airflow guide path 53 is guided to the front edge airflow reservoir portion 52 to become a force thrusting in the front edge direction. Thus, in the wind receiving paddle 5 of the first embodiment, it is possible to utilize the airflow in contact with the convex side surface 512, which has not been conventionally exerted with respect to the rotation of the perpendicular rotation shaft 3 when arranged on the leeward side, as the thrust force toward the front edge.

Next, to be described will be the wind receiving paddle 5D arranged at an interval of 90 degrees in the rotational direction with respect to the wind receiving paddle 5C (the wind receiving paddle 5D arranged on the left side in FIG. 5). With respect to the wind receiving paddle 5D, the wind flows from the front edge side toward the rear edge side. Thus, the wind receiving paddle 5D receives an adverse wind from the front edge side. However, in the wind receiving paddle 5 of the first embodiment, the width of the portion from the concave side surface 511 side toward the convex side surface 512 side of the front edge airflow reservoir portion 52 is small, and the projection area from the front edge side toward the rear edge side is small, so that it is possible to further diminish the force pressing toward the rear edge side due to the adverse wind.

Further, since the wind receiving paddles 5 are substantially of a wing-like configuration, the wind velocity at the convex side surface 512 is higher than the wind velocity at the concave side surface 511. Thus, the convex side surface 512 side is under more negative pressure than the concave side surface 511. Then, the air at the concave side surface 511 is spouted toward the convex side surface 512 side from the airflow guide path 53. Due to the reaction by the spouted airflow, the wind receiving paddles 5 obtain a thrust force in the rotational direction.

Due to the above construction, in the wind receiving paddles 5 of the first embodiment, the wind force received from one direction can be turned into a force rotating all the four wind receiving paddles 5A through 5D toward the front edge side (i.e., rotating them counterclockwise in FIG. 5). While the wind receiving paddle 5D receives a rotating force in a direction opposite to the rotational direction, that force is smaller than the rotational force in the rotational direction of the other three wind receiving paddles 5A through 5C.

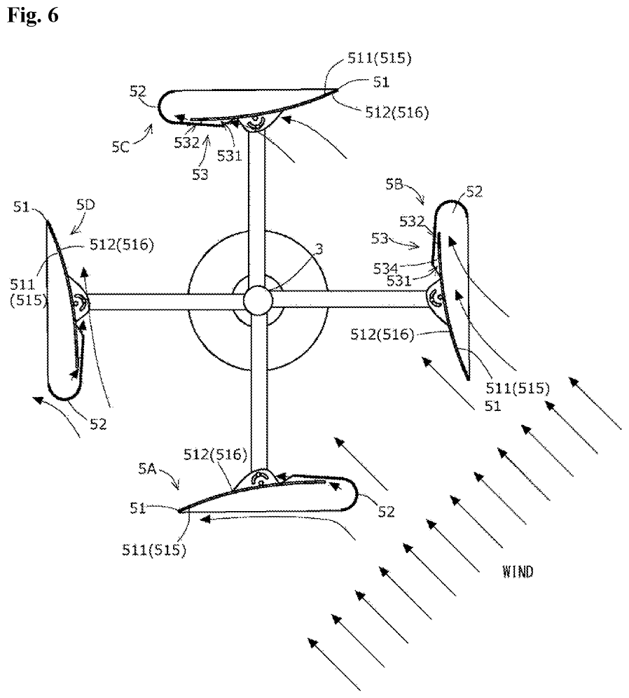

Next, to be described will be the case where the wind blows between one wind receiving paddle 5A and the wind receiving paddle 5B arranged adjacent to the wind receiving paddle 5A (the case where the wind blows obliquely from down right toward upper left at an angle of 45 degrees in FIG. 6). At this time, in the wind receiving paddle 5B, the wind is mainly received by the concave side surface 511 of the concave panel part 51. And the airflow is guided along the concave side surface 511 to the front edge airflow reservoir portion 52 to become a strong force in the direction of the front edge.

In the wind receiving paddle 5C, the airflow strikes the convex side surface 512 from the rear edge side. This airflow is turned into a force pressing the wind receiving paddle 5C in the direction of the front edge. The airflow in contact flows into the airflow guide path 53 along the convex side surface 512, and is guided to the front edge airflow reservoir portion 52 to become a force pressing in the direction of the front edge.

On the other hand, the wind receiving paddle 5A and the wind receiving paddle 5D receive the wind from the front edge side and generate a force in a direction opposite the rotational direction. However, the concave side surface 511 and the convex side surface 512 are formed in a configuration smooth to the flow such as a streamline shape, so that the airflow flows along each surface to weaken the force generated in the direction opposite to the rotational direction. Further, since the wind receiving paddle 5 is substantially of a wing-like configuration, the air is spouted from the airflow guide path 53 to the convex side surface 512 side, and due to the reaction thereof, there is provided a thrust force in the rotational direction.

Thus, the paddles 5 of the first embodiment can generate, even when they receive a wind passing between them, a force in the rotational direction (counterclockwise in FIG. 6). Thus, no matter whether the wind blows to the wind receiving paddle 5 side or between the wind receiving paddles 5, it is possible to exert a force in the rotational direction.

The support arms 4 transmit the converted force in the direction of the front edge due to the wind receiving paddles 5 to the perpendicular rotation shaft 3 as a rotational force (rotational torque).

The perpendicular rotation shaft 3 starts rotation by the rotational force generated by the wind force acting on the wind receiving paddles 5 and transmitted by the support arms 4. The perpendicular rotation shaft 3 is supported in a floating state by the repulsive force of the pairs of upper and lower magnets 6, 6 arranged at two upper and lower positions, and, at the same time, the friction loss in the rotational direction is mitigated by bearings 9, 9. Thus, the perpendicular rotation shaft 3 is started (to rotate) even by a weak rotational force due to a wind force of low velocity. Further, even during rotation, the loss due to the friction with the shaft support stand can be suppressed, so that it is also possible to suppress the power generation loss.

Further, the perpendicular rotation shaft 3 is supported at two or more positions: the portion of the upper portion support portion 22 in the vicinity of the support arms 4 and the portion below that, so that deflection of the wind receiving paddles 5 upon receiving strong wind can be suppressed. Thus, the rotation of the perpendicular rotation shaft 3 can be performed smoothly.

In the wind power generation motor 8, a rotation shaft 81 is rotated by the rotational force of the perpendicular rotation shaft 3 transmitted, and power generation is conducted. At this time, in the rotation transmission mechanism 7, the wind power generation motor 8 is rotated at a rotation speed higher than that of the perpendicular rotation shaft 3, so that it is possible to obtain a larger amount of power.

The wind power generation device 1 of the first embodiment constructed as described above can provide the following effects.

1. The wind abutting the convex side surface 512 from the rear edge side of the wind receiving paddle 5 is guided to the concave side surface 511 side and can be utilized as the force to press the front edge airflow reservoir portion 52, so that it is possible to obtain a larger amount of generated power than in the conventional paddle type wind power generation device 1.

2. In the wind receiving paddle 5, it is also possible to utilize the wind abutting the convex side surface 512, so that by receiving the wind from no matter which of the four directions, it is possible to rotate the perpendicular rotation shaft 3, making it possible to perform efficient power generation.

3. In the wind receiving paddle 5, the wind discharged to the front edge airflow reservoir portion 52 by the airflow guide path 53 is accelerated, so that it is possible to rotate the perpendicular rotation shaft 3 with a stronger force.

4. It is not a paddle type wind power generator which generates power by lift due to a propeller but is one which generates power by converting the force of the wind directly to a rotational force, so that it is possible to start power generation even with a weak wind. In particular, in the wind power generation device 1 of the first embodiment, the perpendicular rotation shaft 3 is supported in a floating state by a plurality of magnets 6, so that the friction with the shaft support stand is suppressed to a minimum, thereby further facilitating the starting.

Next, a wind power generation device according to the second embodiment of the present invention will be described with reference to the drawings. A redundant description of the components of the wind power generation device 1 of the second embodiment that are the same as or equivalent to those of the first embodiment described above will be left out.

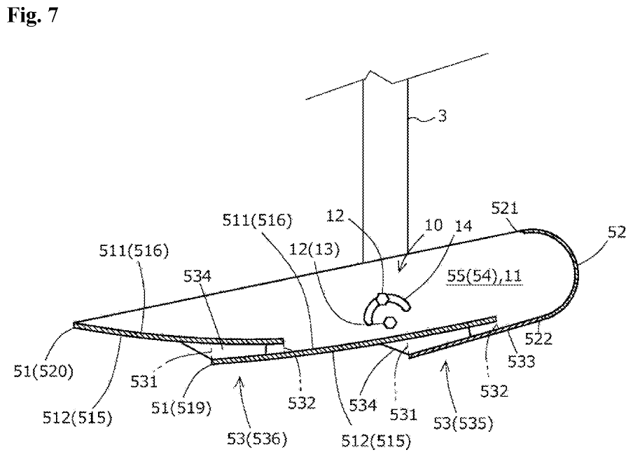

As shown in FIG. 7, the concave panel part 51 of the second embodiment is forced such that the inner side surface 516 is curved in a concave shape in plan view in the state in which it is fixed to the support arm 4.

In addition to the front edge side airflow guide path 535 described above, the airflow guide path 53 of the second embodiment has a rear edge side airflow guide path 536. The rear edge side airflow guide path 536 is formed on the rear edge side of the front edge side airflow guide path 535, and serves to guide the airflow striking the convex side surface 512 of the concave panel part 51 to the concave side surface 511 side. In the second embodiment, the concave panel part 51 is formed by a front edge side concave panel part 519 and a rear edge side concave panel part 520. The rear end of the front edge side concave panel part 519 is arranged on the convex side surface 512 side, and the front edge of the rear edge side concave panel part 520 is arranged so as to overlap the concave side surface 511 side of the rear end, whereby there is formed a rear edge side airflow guide path 536 due to the gap thereof.

Further, in the wind receiving paddle 5 of the second embodiment, in order not to hinder the wind received by the concave side surface 511 from flowing along the concave side surface 511, the support position by the support arm 4 is not the concave side surface 511 of the concave panel part 51 but the lower edge airflow stop portion 55 and the upper edge airflow stop portion 54. Thus, as shown in FIGS. 7 through 9, the lower edge airflow stop portion 55 and the upper edge airflow stop portion 54 have a bolt hole 13 and an elongated hole 14 in order to also serve as the support plate 11 of the angle adjustment mechanism 10.

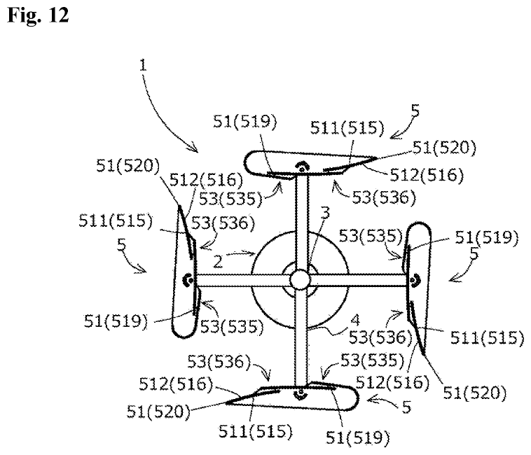

While the front edge side airflow guide path 535 and the rear edge side airflow guide path 536 of the second embodiment have a concave panel part 51 the inner side surface 516 of which is curved into a concave shape in plan view, this should not be construed restrictively. As shown in FIG. 12, they may have a concave panel part 51 the outer side surface 515 of which is curved into a concave shape in plan view. Further, although not shown, the concave panel part 51 may form a front edge side concave panel part 519 and a rear edge side concave panel part 520 by a panel that is linear in plan view, with the rear end of the front edge side concave panel part 519 overlapping the front edge of the rear edge side concave panel part 520 to form a rear edge side airflow guide path 536.

Next, the operation of each component of the wind power generation device 1 of the second embodiment will be described.

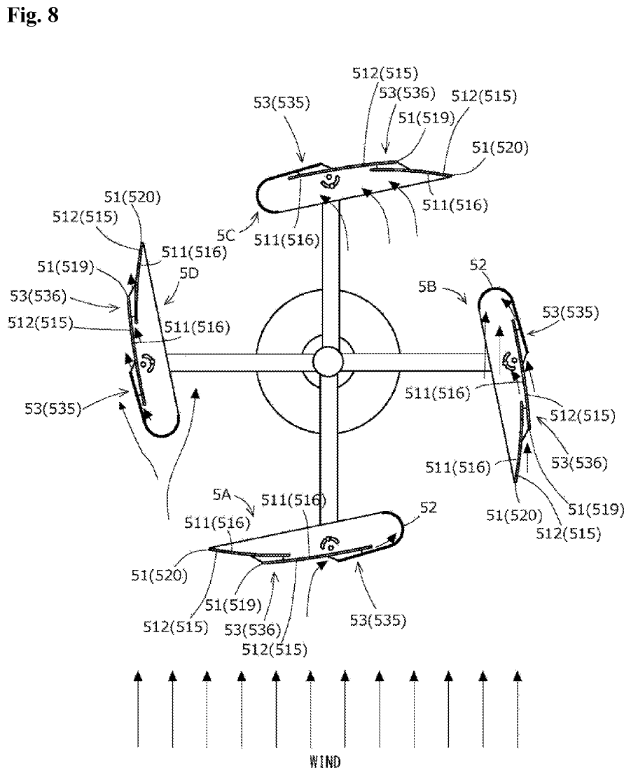

To be described will be the case where as shown in FIG. 8, the wind power generation device 1 of the second embodiment receives a wind blowing from the direction of one wind receiving paddle 5A in the direction of the wind receiving paddle 5C that is opposite thereto with respect to the perpendicular rotation shaft 3 (a wind heading upwards from below in FIG. 8).

In this case, in the wind receiving paddle 5A situated on the most windward side, the wind is mainly received by the convex side surface 512 of the concave panel part 51. Since the convex side surface 512 is curved and inclined toward the front edge side, the concave panel part 51 guides the airflow striking the convex side surface 512 from the rear edge side to the front edge side along the convex side surface 512.

In the front edge side airflow guide path 535, the airflow striking the convex side surface 512 from the rear edge side to the concave side surface 511 side to guide it to the front edge airflow reservoir portion 52. Then, at the front edge airflow reservoir portion 52, the guided wind is turned into a force pressing in the direction of the front edge. When the wind receiving paddle 5A rotates in the rotational direction even to a small degree, the airflow also easily enters the rear edge side airflow guide path 536, and the airflow striking the convex side surface 512 on the rear side is guided to the concave side surface 511 side and id guided to the front edge airflow reservoir portion 52 to be turned into a force which can be applied as a pressing force toward the front edge.

Next, in the wind receiving paddle 5B arranged at an interval of 90 degrees in the rotational direction with respect to the wind receiving paddle 5A (the wind receiving paddle 5B arranged on the right-hand side in FIG. 8), the wind is flowing from the rear edge side toward the front edge side. Thus, the airflow flowing on the concave side surface 511 of the concave panel part 51 is guided to the front edge airflow reservoir portion 52 along the concave panel part 51, or flows directly into the front edge airflow reservoir portion 52 to become a force pressing in the front edge direction.

The airflow striking the convex side surface 512 of the concave panel part 51 flows along the convex side surface 512. In the second embodiment, the airflow guide path 53 is formed by the front edge side airflow guide path 535 and the rear edge side airflow guide path 536 arranged on the rear edge side of the front edge side airflow guide path 535, so that the airflow striking the portion of the convex side surface 512 on the front edge side flows into the front edge side airflow guide path 535, and the airflow striking the portion of the convex side surface on the rear edge side of the formation position of the rear edge side airflow guide path 536 flows into the rear edge side airflow guide path 536.

The airflow having flowed into the front edge side airflow guide path 535 and the rear edge side airflow guide path 536 is accelerated, and is guided to the front edge airflow reservoir portion 52. Thus, by the strong force accelerated from the convex side surface 512 to the concave side surface 511 side by the airflow guide paths 535 and 536, the airflow is turned into a force pressing the front edge airflow reservoir portion 52 in the direction of the front edge. In this way, by forming a plurality of airflow guide paths 53 in the concave panel part 51, it is possible to guide more of the airflow striking the convex side surface 512 from the rear edge side to the concave side surface 511 side and to utilize it as a force pressing in the direction of the front edge.

Next, in the wind receiving paddle 5C arranged at a further interval of 90 degrees in the rotational direction with respect to the wind receiving paddle 5B (the wind receiving paddle 5C arranged on the leeward side in FIG. 8), the wind is mainly received by the concave side surface 511 of the concave panel part 51. In the concave panel part 51, the concave side surface 511 side is curved and inclined toward the front edge side, so that the wind received is guided from the rear edge side to the front edge side along the curved surface (the concave side surface 511). In the front edge airflow reservoir portion 52, the airflow guided along the curved surface is received and turned into a force pressing in the direction of the front edge.

Next, in the wind receiving paddle 5D arranged at a further interval of 90 degrees in the rotational direction with respect to the wind receiving paddle 5C (the wind receiving paddle 5D arranged on the left-hand side in FIG. 8), an adverse wind from the front edge side is received. However, as in the wind receiving paddle 5 of the first embodiment, the width from the concave side surface 511 side toward the convex side surface 512 side of the front edge airflow reservoir portion 51 is small, and the projection area from the front edge side toward the rear edge side is small, so that it is possible to diminish the force exerted so as to press toward the rear edge side by the adverse wind. While the second embodiment has a plurality of airflow guide paths 53, their influence on the projection area is small. Thus, there is no air resistance to the rotation due to the provision of a plurality of airflow guide paths 53. Further, due to the difference in wind velocity between the concave side surface 511 and the convex side surface 512, the pressure is more negative at the convex side surface 512 side than at the concave side surface 511 side. The air at the concave side surface 511 is spouted to the convex side surface 512 side from the front edge side airflow guide path 535 and the rear edge side airflow guide path 536, and a thrust force in the rotational direction is provided due to the reaction thereof.

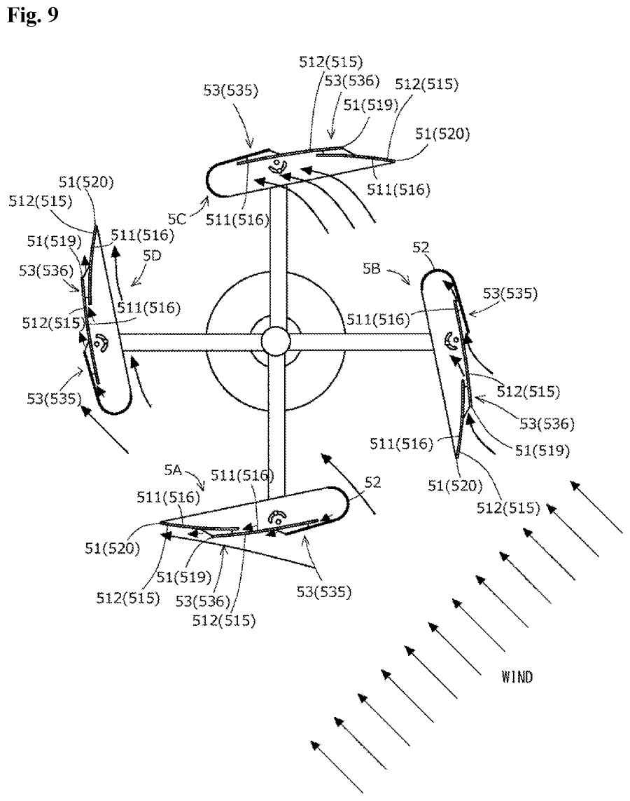

In the case where the wind blows between one wind receiving paddle 5A and the wind receiving paddle 5B arranged adjacent to the wind receiving paddle 5B (in the case where the wind blows obliquely from lower right to upper left at an angle of 45 degrees in FIG. 9), in the wind receiving paddle 5B, the wind is mainly received by the convex side surface 512 of the concave panel part 51. And the airflow flows along the convex side surface 512 to flow into the front edge side airflow guide path 535 and the rear edge side airflow guide path 536. Then, the airflow is guided to the front edge airflow reservoir portion 52 to become a strong force in the direction of the front edge.

In the wind receiving paddle 5C, the wind is mainly received by the concave side surface 511 of the concave panel part 51. Thus, this airflow is guided to the front edge airflow reservoir portion 52 along the concave side surface 511, or flows directly into the front edge airflow reservoir portion 52 to become a force pressing in the direction of the front edge.

On the other hand, the wind receiving paddle 5A and the wind receiving paddle 5D receives the wind from the front edge side to generate a force in a direction opposite the rotational direction. Further, in the second embodiment, there are provided a plurality of airflow guide paths 53. However, the concave side surface 511 and the convex side surface 512 receiving the wind are formed in a smooth configuration with respect to the flow such as a streamline shape along with the front edge side airflow guide path 535 and the rear edge side airflow guide path 536, so that the airflow flows along each surface and weakens the force generated in the direction opposite to the rotational direction, and there is no hindrance to the rotation in the form of air resistance due to the provision of a plurality of airflow guide paths 53. Further, since the wind receiving paddles 5 are substantially of a wing-like configuration, air is spouted to the convex side surface 512 side from the front edge side airflow guide path 535 and the rear edge side airflow guide path 536, and there is provided a thrust force in the rotational direction due to the reaction thereof.

In the wind power generation device 1 of the second embodiment constructed as described above, it is possible to attain the same effect as that of the first embodiment, and, at the same time, due to the plurality of airflow guide paths 53, more of the airflow striking the convex side surface 512 from the rear edge side can be guided to the concave side surface 511 side, making it possible to efficiently utilize the airflow striking the convex side surface 512 for power generation. Further, there is scarcely any effect hindering the rotation due to the provision of a plurality of airflow guide paths 53, so that they can be provided as appropriate taking the manufacturing cost, etc. into consideration. Further, while in the concave panel part 51 of the second embodiment the inner side surface 516 is curved into a concave shape in plan view, even if winds blowing from various directions are received, it is possible to rotate the perpendicular rotation shaft 3 to perform efficient power generation.

The wind power generation device according to the present embodiment is not restricted to the embodiments described above but allows modifications as appropriate. For example, there are no particular restrictions regarding the materials used for the members, and they may be selected as appropriate taking the weight, price, etc. into consideration.

### REFERENCE SIGNS LIST

1 wind power generation device
2 shaft support stand
3 perpendicular rotation shaft
4 support arm
5 wind receiving paddle
6 magnet
7 rotation transmission mechanism
8 wind power generation motor
9 bearing
10 angle adjustment mechanism
11 support plate
12 support bolt
13 bolt hole
14 elongated hole
21 main body portion
22 upper portion support portion
51 concave panel part
52 front edge airflow reservoir portion
53 airflow guide path
54 upper edge airflow stop portion
55 lower edge airflow stop portion
81 rotation shaft
511 concave side surface
512 convex side surface
513 front edge part
514 rear edge part
515 outer side surface
516 inner side surface
517 upper edge portion
518 lower edge portion
519 front edge side concave panel part
520 rear edge side concave panel part
521 distal end portion
522 rear end portion
531 airflow introduction port
532 airflow discharge port
533 airflow guide plate
534 partition
535 front edge side airflow guide path
536 rear edge side airflow guide path

1. A wind power generation device comprising: a perpendicular rotation shaft transmitting a rotational force to a wind power generation motor; a plurality of support arms arranged at equal intervals with respect to a circumferential direction and radially from the perpendicular rotation shaft; and a wind receiving paddle connected to a distal end of each support arm,
wherein the wind receiving paddle has: a concave panel part vertically elongated and formed by curving or bending an inner side surface or an outer side surface into a concave shape in plan view; and a front edge airflow reservoir portion which is formed to protrude to a concave side surface side along a longitudinal direction of a front edge part in a rotational direction of the concave panel part and a distal end portion of which is formed by being curved or bent to a rear edge side, and
the concave panel part has an airflow guide path which is formed along the longitudinal direction of the wind receiving paddle and which serves to introduce an airflow striking the convex side surface from the rear edge side to the concave side surface side to guide the airflow to the front edge airflow reservoir portion.

2. The wind power generation device according to claim 1, wherein the airflow guide path has a front edge side airflow guide path which is on the convex side surface side of the front edge part of the concave panel part and which is formed along the longitudinal direction thereof.

3. The wind power generation device according to claim 2, wherein the airflow guide path has, along with the front edge side airflow guide path, a rear edge side airflow guide path which is on the rear edge side of the front edge side airflow guide path and which serves to guide the airflow striking the convex side surface on the rear edge side of the formation position thereof to the concave surface side.

4. The wind power generation device according to claim 1, wherein the airflow guide path is formed so as to be gradually narrowed from the rear edge side toward the front edge side.

5. The wind power generation device according to claim 1, wherein the perpendicular rotation shaft is rotatably supported by a shaft support stand in a floating state by a repulsive force of pairs of upper and lower magnets provided at a plurality of positions along the axial direction.
